(19) United States
(12) Patent Application Publication
(10) Pub. No.: US 2007/0268349 A1
(43) Pub. Date: Nov. 22, 2007

(54) Heating Magnetically Orientable Pigment In A Printing Process

(75) Inventor: Eric William Kurman, Healdsburg, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, Milpitas, CA (US)

(21) Appl. No.: 11/749,300

(22) Filed: May 16, 2007

Related U.S. Application Data
(60) Provisional application No. 60/801,652, filed on May 19, 2006.

(51) Int. Cl. B41J 2/01

(52) U.S. Cl. 347/102

(57) ABSTRACT

A printing apparatus and method for aligning special effect flakes is disclosed. The flakes field orientable and have an absorption band of wavelengths and a reflection band of wavelengths and are dispersed within in a viscous paste-like ink. The absorption band of the flakes is more absorbing than reflecting and the reflecting band is more reflecting than absorbing. A laser diode array is provided for generating beams of light positioned to irradiate the paste-like ink coating on the substrate so as to lessening the viscosity of the paste like ink by irradiating with light. Preferably at least 45% of the optical power of the one or more beams of light is in the absorption band of the flakes. After the flakes are heated to lessen the viscosity of the ink, a magnetic field is applied so as to orient the flakes within the ink.

### CROSS-REFERENCE TO RELATED APPLICATIONS

This application claims priority of U.S. Provisional Patent Application No. 60/801,652 filed May 19, 2006, entitled “Laser Heating Method For Magnetically Orientable Pigment Printing Process” which is incorporated herein by reference for all purposes.

### FIELD OF THE INVENTION

This invention relates to a method and device for selectively heating pigment contained in an inked coating to lessen the viscosity of a viscous ink medium.

### BACKGROUND OF THE INVENTION

Intaglio printing is a well known printing method using a printing plate having recesses formed in printing image areas with respect to non-printing image areas. After the entire intaglio printing plate is filled with a highly viscous ink, the ink on the non-printing image areas is wiped off to leave the ink only in the printing image areas. Thereafter, a web or substrate such as a paper sheet is forced directly to the printing plate under heavy pressure to transfer the ink remaining in the printing image areas onto the paper. Line-engraved intaglio printing is typically used for printing security documents, such as banknotes, and uses printing cylinders having engravings therein in which intaglio printing inks have been deposited. The highly viscous paste-like intaglio inks used in such printing are substantially different in nature from inks used in other forms of printing such as gravure, offset and ink-jet printing. To varying degrees of success, attempts have been made to improve the dispersibility and chemical resistance of the paste-like intaglio inks; for example U.S. Pat. No. 6,833,395 in the name of Rygas et al. assigned to the Canadian Bank Note Company, Limited (Ottawa, Calif.) attempts to provide a solution to this problem.

Another United States patent that relates to enhancements within an intaglio printed image and suggesting the addition of dielectric flakes within the intaglio ink, is U.S. Pat. No. 6,815,065, in the name of Argoitia et al., assigned to Flex Products Inc, incorporated herein by reference. The '065 patent discloses drawing down ink or paint which generally flattens the pigment flakes in the plane of the surface of the substrate.

As of late there has been considerable interest in obtaining special affects by magnetically orienting magnetic flakes, that is, flakes that will align in a magnetic field, in a predetermined manner, to follow the field lines. Examples are found in U.S. Pat. No. 6,902,807 in the names of Argoitia et al., entitled Alignable diffractive pigment flakes, and U.S. Pat. No. 6,808,806 in the names of Phillips et al., entitled “Methods for producing imaged coated articles by using magnetic pigments”. Phillips et al., disclose orienting magnetically orientable flakes in applied magnetic fields to achieve special affects; both of these patents are incorporated herein by reference.

Printing of secure labels and valuable documents with illusive optical effects based on utilization of low-viscosity magnetic optically variable flexo and silk-screen inks, is described in detail in US Patent Application 20040051297 assigned to Flex Products Inc., and is incorporated herein by reference.

Optically variable prints for other security documents and currencies are often printed on sheet-fed intaglio presses. The printing process involves enormous pressures (tons/sq-in) on the paper in the ink transfer from the plate, high press speeds (200-500 ft/min), ultra viscous nature of the ink, and fast kinetics of the surface drying.

Intaglio printing of security insignias is employed because of the unique properties that can be attained. The achievement of these special properties places strict requirements on the ink, the engraved plate, and the process conditions employed. For example, after completion of printing the ink must maintain a specific morphology and configuration i.e. separate islands or strings that accurately replicate the fine detail of the parent engraving. Therefore, the conventional steps of printing and curing and the new steps of aligning must still provide the same physical, chemical, and mechanical properties to the cured ink while at the same time enabling the accurate reproduction of the engraved image and predetermined position of magnetic particles. The concomitant requirements of stringently maintaining the correct visco-elastic properties of the paste-like ink while enabling a sequence of new and added steps to cause alignment of magnetic flakes presented a tremendous challenge to those skilled in the art.

The achievement of printed and cured insignias encompassing magnetic flakes that have been aligned in a desired and predetermined manner requires a solution that overcomes a difficult set of constraints. For example, the paste-like ink must be able to provide not only the normal drop and rise in viscosity that results from the printing step but must also be capable of surviving a second drop and rise in viscosity during the new alignment step. Complicating matters, the second viscosity spike takes place after application of ink to substrate rather than in the fluid state. To support high-speed printing, the printed but uncured ink must provide this viscosity drop-rise quickly so as not to slow down the line speed of the press. In the high-speed example, the magnetic flakes must orient quickly in the dwell time provided by the magnet apparatus, sometimes in less than one second. Once in the desired position, the flakes must freeze in place and avoid the natural relaxation that will occur unless the proper steps are followed. This fixing of the flake position must be permanent and must survive the lifetime of the security document—a period of years in the case of a circulating banknote.

Besides requirements placed on the ink, the magnets, and the magnetic flakes, the process is additionally constrained. For example, when energy is applied to the ink to reduce viscosity, the energy must be applied in a manner and with amplitude sufficient to cause the desired change to the ink without damaging the materials involved with the process. For example, the heat or other energy must not scorch or damage the ink or the substrate; usually paper or polymer. The added energy must not damage the printing press. The type of energy must be compatible with the mechanical hardware in the alignment zone. For example, application of microwave energy to a press zone containing metallic elements could be hazardous.

Thus, when one attempts printing using thick, highly viscous paste-like inks having magnetic flakes or particles therein, alignment of these flakes using standard intaglio-like processes and inks is less than satisfactory as the high-viscosity of the paste-like ink prevents the magnetically alignable flakes from moving and reorienting within the carrier; therefore, heretofore, alignment using an applied magnetic field with highly viscous paste-like inks has not been practicable.

It is therefore an object of this invention to provide a method and apparatus that will allow these highly viscous paste-like inks to be utilized in the printing of special effect pigments wherein the pigments can be aligned in preferred orientations using a magnetic field so as to yield desired illusionary affects.

It is a further object of this invention to provide magnetically orientable flakes fixedly oriented in a preferred orientation wherein the flakes are initially disposed in a paste-like ink having a viscosity of at least 100-200 Pas when the ambient temperature is in a range of 15-30 degrees C.

### SUMMARY OF THE INVENTION

In accordance with the invention there is further provided a method of printing and aligning special effect flakes, such that at least some of the printed flakes orient along field lines of an applied field, the method comprising the steps of:
a) providing a paste-like ink, comprised of a carrier having flakes therein having an absorption band of wavelengths and a reflection band of wavelengths, wherein the absorption band is more absorbing than reflecting and wherein the reflecting band is more reflecting than absorbing and wherein the flakes are comprised of at least a layer of field orientable material;
b) applying the paste like ink by printing said ink upon a substrate;
c) lessening the viscosity of the paste like ink by adding optical energy having at least 50% of its optical power in the absorption band of the flakes; and,
d) reorienting the flakes using the applied field to form the image.

It is preferred that at lest 50% of the optical energy be in the absorption band of the flakes; this can conveniently be achieved since the laser diode bandwidth is generally much narrower than the absorption bandwidth of the pigment, whether this is an interference pigment or conventional dye/carrier pigment.

In an aspect of the invention at at least 45% of the optical power of the one or more beams of light is in the absorption band of the flakes. In addition to the steps above there is the step of allowing the paste-like ink to recover its viscosity such that the aligned special effect flakes are preserved through the curing process of the ink.

In an aspect of the invention the flakes of the paste-like ink are at least 50% absorbing over a band of wavelengths Wₐ₁ to Wₐ₂, and wherein the one or more beams of light provide optical energy in a band of wavelengths included within Wₐ₁ to Wₐ₂ so as to heat the flakes or ink vehicle or both, and thereby lessen the viscosity of the paste-like ink such that the flakes can be reoriented in the applied field, wherein the field is a magnetic field.

Preferably at least some of the flakes of the paste-like ink are at least 70% reflective over a band of wavelengths Wᵣ₁ to Wᵣ₂ and wherein said flakes are at least 70% absorbing over a band of wavelengths Wₐ₁ to Wₐ₂, wherein the step of lessening the viscosity of the paste like ink by adding optical energy includes utilizing an optical source having sufficient energy between the wavelengths Wₐ₁ and Wₐ₂.

In a most preferred embodiment of the invention the optical source includes one or more laser diodes having at least 80% of their optical energy within a band of wavelengths between Wₐ₁ and Wₐ₂.

In accordance with another aspect of the invention there is provided a printing apparatus for aligning special effect flakes having an absorption band of wavelengths and a reflection band of wavelengths in a paste-like ink wherein the absorption band is more absorbing than reflecting and wherein the reflecting band is more reflecting than absorbing and wherein the flakes are comprised of at least a layer of field orientable material comprising:
a) means for moving a substrate coated with the paste-like ink;
b) means for generating one or more beams of light positioned to irradiate the paste-like ink coating on the substrate so as to lessen the viscosity of the paste like ink by irradiating with the one or more beams of light, wherein at least 50% of the optical power of the one or more beams of light is in the absorption band of the flakes; and,
c) means for providing a magnetic or electric field for reorienting the flakes using the applied field to form the image.

### BRIEF DESCRIPTION OF THE DRAWINGS

Exemplary embodiments of the invention will now be described in conjunction with the figures in which:

FIG. 1 is a schematic diagram illustrating an intaglio printing process, wherein a magnetic field is disposed adjacent a print roller and wherein a heat source is provided to temporarily lessen the viscosity of the ink prior to alignment of flakes within the ink.

FIG. 2 is a schematic diagram illustrating an intaglio printing process in accordance with this invention, wherein a magnetic field is disposed adjacent a print roller and wherein a diode array light source is provided to temporarily lessen the viscosity of the ink prior to alignment of flakes within the ink.

FIG. 3 is a graph illustrating the absorption and reflectance spectrum of optically variable gold-to-green magnetic pigment.

FIG. 4 is a detailed schematic diagram illustrating a coated paper substrate disposed between a laser diode array and an array of magnets for aligning flakes within the coating.

FIG. 5 is a schematic side view of an apparatus for high speed printing of magnetically aligned images in accordance with this invention wherein a substrate is carried by a moving conveyor belt or web.

FIG. 6 shows a spectral scan of cured intaglio vehicle on banknote paper.

### DETAILED DESCRIPTION

A novel process is provided for the printing of securities and high-value documents which allows paste-like ink having magnetic platelets or flakes dispersed therein to be oriented in a magnetic field. The paste-like viscous ink preferably comprises flakes of optical interference pigment, or flakes of a reflective pigment, or single layer or multi layer diffractive pigment flakes having magnetic properties. This invention similarly lends itself to any alignment method wherein flakes can be aligned in a preferred orientation using any forces that are practicable. For example, particles movable in electric or magnetic fields that can force the special effect flakes in a desired orientation, may benefit from this invention, wherein paste-like printing inks having flakes therein can be temporarily made less viscous during alignment.

In one example, the interference pigment is an optically variable pigment that contains a thin layer of magnetic material adjacent thereto. The pigment is dispersed in a high-viscosity carrier that may contain additional solvents or a cure retarder to keep the ink layer fluid during transition of the print through the magnetic zone; preferably in the range of 4-40 Pas at the temperature of 40 degrees C. or more. Printing of the image with magnetic paste-like ink occurs in the press where magnets are either embedded into the impression cylinder or located along the pass line of the substrate as close as practicable to the impression cylinders.

Conceptually, the ideal environment for an illusionary optical effect, generated in an applied magnetic field, is the one that maximizes the dwell time of a “fluid” ink layer in a region of high magnetic flux concentration, coupled with a vehicle system that has the correct visco-elastic properties to allow for magnetically permeable flakes to orient during the time spent in the magnetic zone.

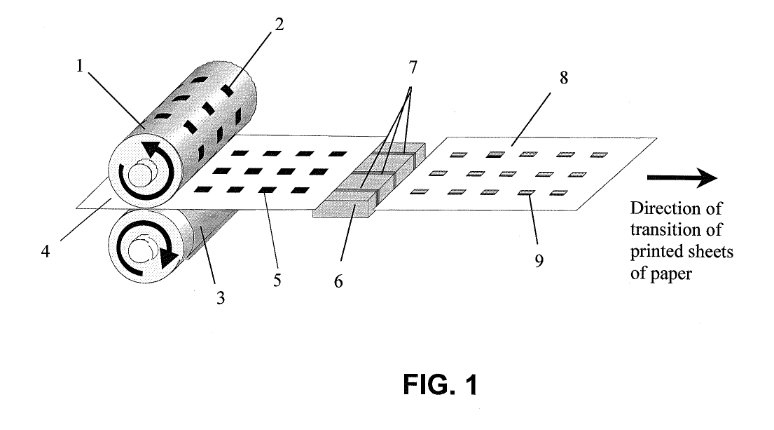

FIG. 1 illustrates an embodiment wherein a printing press is equipped with magnetic hardware for providing an illusionary optical effect. Typically, illusionary optical effects are achieved by alignment of flakes dispersed in a liquid ink vehicle along lines of an applied magnetic field in a predetermined, varying manner, for example such that some of the flakes are purposely oriented differently than others. For example, some flakes may be standing on their edges, while others may be lying flat, and, or, some flakes may be tilted to varying degrees between flat lying and edge standing flakes. The hardware is placed directly down the web as is shown in FIG. 1 and as close to the printing and impression cylinders as possible. Sheets of freshly printed optically variable ink are conveyed over the magnetic lines, with a vertical separation between the magnet surface and the ink surface no greater than about 1 inch. The freshly deposited ink is fluidized by the application of sufficient heat energy applied from heated rollers to lessen the viscosity of the ink coating upon a web to allow the magnetic pigment particles, dispersed in the ink vehicle, to align themselves parallel to the applied field lines. The printing roller 1 has number of engravings 2 in the shape of a desired image on the printing plate wrapping the roller. Printing roller 1 and impression roller 3 touch each other and rotate in opposite directions. A web in the form of a sheet of paper 4, inserted between the rollers, moves from the left to the right. The web could alternatively take the form of a continuous roll of paper, film, or polymer. The moment when the paper is positioned exactly between the rollers, an engraving holding the paste-like ink comes to this point and the ink is transferred onto the paper forming printed image 5. The image 5 shown in the picture is a solid filled rectangle. The previously printed sheet of paper 8 moves over the top of linear magnetic assembly 6 with permanent magnets 7 immediately after completion of the printing. Designs of hardware for linear magnetic effects have been described in the aforementioned patents. According to these patents and patent applications, when passed through the magnetic field, the magnetic particles become aligned in the direction of the lines of a magnetic field. As a result, in one example a linear “rolling bar” optical effect 9 appears in the print. This is shown and described in United States Patent application 20050106367, in the name of Raksha et al., filed Dec. 22, 2004 incorporated herein by reference.

Referring once again to FIG. 1, as printed sheets of, for example, banknotes are rapidly conveyed from the impression cylinder 3 to a stacking unit, the sheets are exposed to high volumes of ambient air. One result of this air is to affect an almost immediate surface drying reaction. From the time optically variable ink is printed to the time the sheets are stacked, which is generally less than one minute, the ink viscosity increases rapidly, and the sheets can be stacked without offsetting. It is preferred that this print-to-stack duration be held below 5 minutes to minimize the number of sheets in transit.

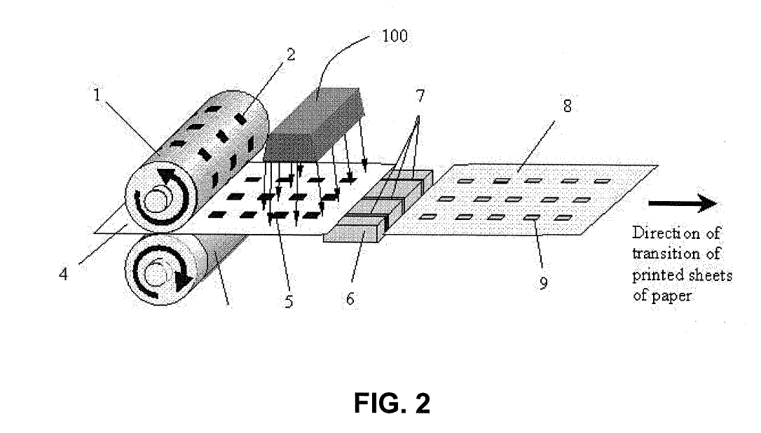

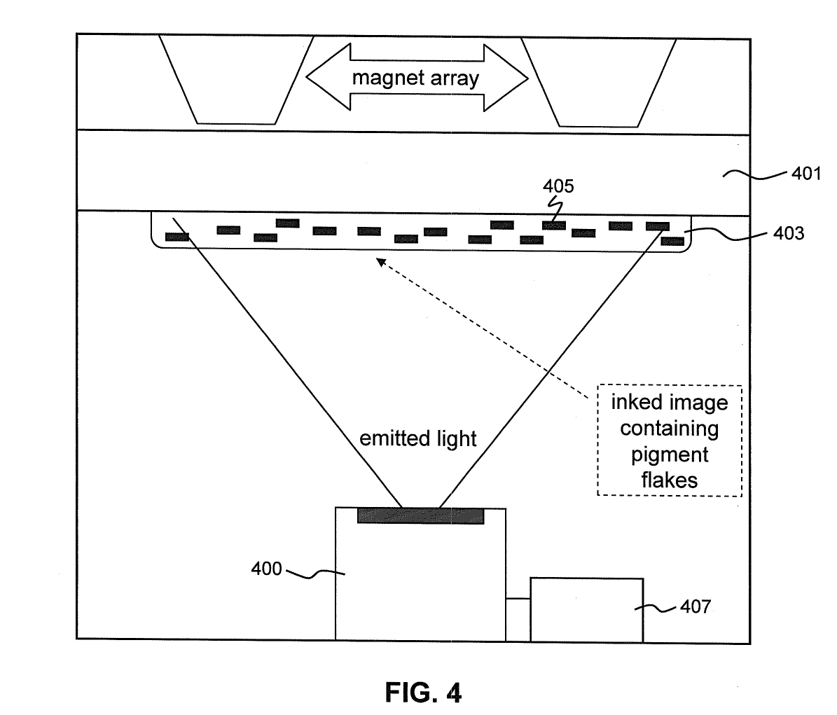

The thick paste like Intaglio ink vehicle requires heating in order to allow “leafing” or orientation of the optically variable pigment flakes to occur. This is seen in ordinary intaglio printing, such as is now used on US banknotes, where elevated temperature and pressure on the printing press are needed to enhance the optically variable feature. These temperature and pressure conditions are created in the contact zone where the substrate moves between printing plate and impression roller. However, in the magnetic orientation process, the Intaglio optically variable magnetic ink (OVMI) is no longer within the press contact zone. The inked image is still uncured, but is transported along the printing line to an alignment device that applies the external magnetic or electric field. Since the paper substrate is thin and loses heat quickly, the inked image must be heated just prior to or during field orientation to reduce the intaglio vehicle viscosity. For the magnetic orientation steps to be compatible with the high-speed printing process characteristics, the ink is heated in a novel manner as is shown in FIG. 2 by irradiating the ink with light from a diode array 100 that is relatively matched in wavelength to a wavelength at which the flakes within the OVMI paste like ink are highly absorbing, so as to heat the flakes, which by way of conduction heats the paste-like ink vehicle to lessen the viscosity of the paste-like ink. The diode array is shown in situ within the printing apparatus in FIGS. 2 and 4. Using diodes in this manner is found to be advantageous over using heated rollers or utilizing heated air blown onto the paper substrate that bears the inked image. By using heated air, heat is transferred to the vehicle (allowing its viscosity to decrease) by convective transfer from the heated air to the paper substrate and to the vehicle as well as by conduction from the paper substrate into the vehicle. The heated air is very effective at transferring heat to the paper substrate, so much so that the paper must be kept moving through the heated zone to prevent its browning or charring. However, the paper is subject to heat damage and the paper outside the inked image is heated needlessly. A significant advantage of utilizing an optical source having a wavelength substantially matched to an absorption spectrum of the magnetic flakes is that the flakes are targeted in a highly controllable manner. In this way the paste is essentially heated from the inside, relatively uniformly as the flakes are relatively uniformly distributed within the paste like ink, without damaging the substrate. In order to understand the difference between this invention and the prior art method of heating the paper with very hot air, one can consider blowing heated air as tantamount to holding a blow torch a distance away from the object to be heated and moving the object and the torch relatively so as to prevent scorching. In contrast this invention essentially provides a plurality of heat sources buried within the ink vehicle itself which obtain their heat energy from a particular wavelength of light irradiating the particles within the ink in their absorption band, which together generate the required heat to lessen the viscosity of the paste like carrier. Another advantage of using the diode array is that the array can be positioned near, at, or over the magnetic alignment stage so as to minimize cooling that would otherwise occur, for example when using heated rollers distal from the magnetic alignment stage.

Optional utilization of a cure retarder, such as clove oil and others provides additional methods to prevent the ink surface from skinning over prior to the sheet reaching the magnet apparatus.

In order to freeze the magnetic flakes while still in the magnetic field, a UV light source or electron beam unit may be mounted opposite to the alignment magnets and is switched on after the flakes are aligned. Alternatively, the UV light source can be positioned near the magnetic stage 7. As the substrate continues to move, it arrives at the curing zone of the curing source and the ink solidifies fixing the magnetic flakes in the preferred tilted position in dependence upon the field. In some instances curing can be effected through an “oxidative” method where simple exposure to the oxygen in ambient air provides oxidation sufficient to cure and crosslink the ink vehicle.

Although in the previous example, a 60% reduction in viscosity was sufficient to allow alignment of the flakes in the field, in other instances depending upon the viscosity of the ink, a reduction of viscosity of more than 80% is preferable.

Optically variable magnetic pigment (OVMP), similarly to optically variable pigment (OVP), develops its color effect by selective reflection of different wavelengths (colors) of light within the visible spectrum. The “peaks” in the reflectance spectrum are interspersed with “valleys” of low reflectance at wavelengths where the layer structure is an extremely efficient absorber of optical energy. For example, FIG. 2 shows the calculated reflectance of Gold-to-Green OVMP in the VIS and NIR spectral regions at an angle of 8 degrees. The interference structure has high reflectance peaks at about 405 nm, 605 nm, and 1235 nm and valleys at about 470 nm and 805 nm. The reflectance “valley” at 805 nm has a maximum absorptance of 90% but the absorptance is still very high at wavelengths nearby, thereby being relatively high in a band of wavelengths about this maximum.

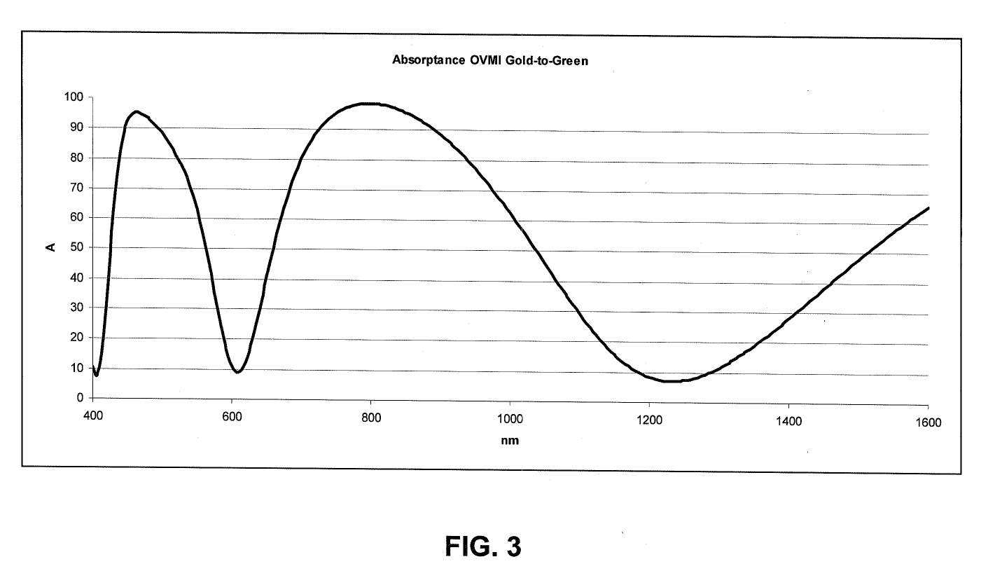

FIG. 3 shows the absorptance of Gold-to-Green OVMP. The layer structure is opaque so the absorptance can be approximated as (100%−R). If optical energy at or near 805 nm is presented to the interference stack it will be converted into heat.

Commercially produced laser diodes are available for a variety of wavelengths primarily in the NIR. These laser diodes are distinguished from lasers by having a wider wavelength distribution of emitted radiation, a wider angular distribution, and a higher noise content in emitted optical power (typically measured from 2 Hz to 2 MHz). Laser diodes can be combined into “bar” structures where several such diodes are ganged together with common electrical power distribution and cooling to obtain substantial optical power. For example, Newport Corporation “ProLite® Multi-Bar Module” provides up to 100 W of output at 808 nm and is suitable for use in Graphic Arts and Printing (see http://www.newport.com/store/genproduct.aspx?id=368157&lang=1033&Section=Detail). This is only one example; 808 nm is a common output wavelength and several manufacturers make such bars available. The “ProLite® Multi-Bar Module” has a beam divergence of 38° and a variation in output wavelength of 808 nm±3 nm. FIG. 4 shows the configuration of the individual laser diodes forming the diode array. Referring now to FIG. 4 a laser diode array 400 is disposed a predetermined distance from the inked paper substrate 401 having a coating 403 of magnetically alignable flakes thereon. As the flakes 405 within the coating are heated sufficiently they begin to move due to the force of the magnetic field. The alignment of the flakes is dependent upon the shape of the magnetic field. A control circuit 407 is electrically coupled to the diode array for controlling the output power of the laser diodes.

Preferably the spectral power distribution of the diodes is contained within ±5 nm bandwidth. Preferably the beam divergence is greater than 15 degrees.

In a preferred embodiment of this invention flakes are selectively heated by irradiating the flakes with a wavelength of light that is substantially matched to an absorption band of wavelengths of the flakes.

In an alternate embodiment of this invention, the ink vehicle itself can be heated by irradiating the ink vehicle with a wavelength of light that is matched to the vehicle's absorption band. In a preferred embodiment of this aspect of the invention, if the ink vehicle is opaque in an output wavelength band of the laser diodes, heating will be selective due only to the geometric factors of the beam output. Instead of indiscriminately heating the entire surface of the paper in order to heat a small patch of ink, one or more diode arrays are selectively positioned in such a fashion so as to heat only the absorbing ink vehicle in the areas where the viscosity is to be reduced. In this instance the flake properties do not matter since the vehicle is absorbing the optical energy. Thus in this embodiment of the invention diodes are selectively positioned to heat selective regions of the coated substrate and the diodes can be controlled by a suitable programmed controller having a processor to rapidly ramp up and increase and ramp down and decrease the optical power to the diodes so that the un-inked portions of the paper, along the line of travel, are not heated.

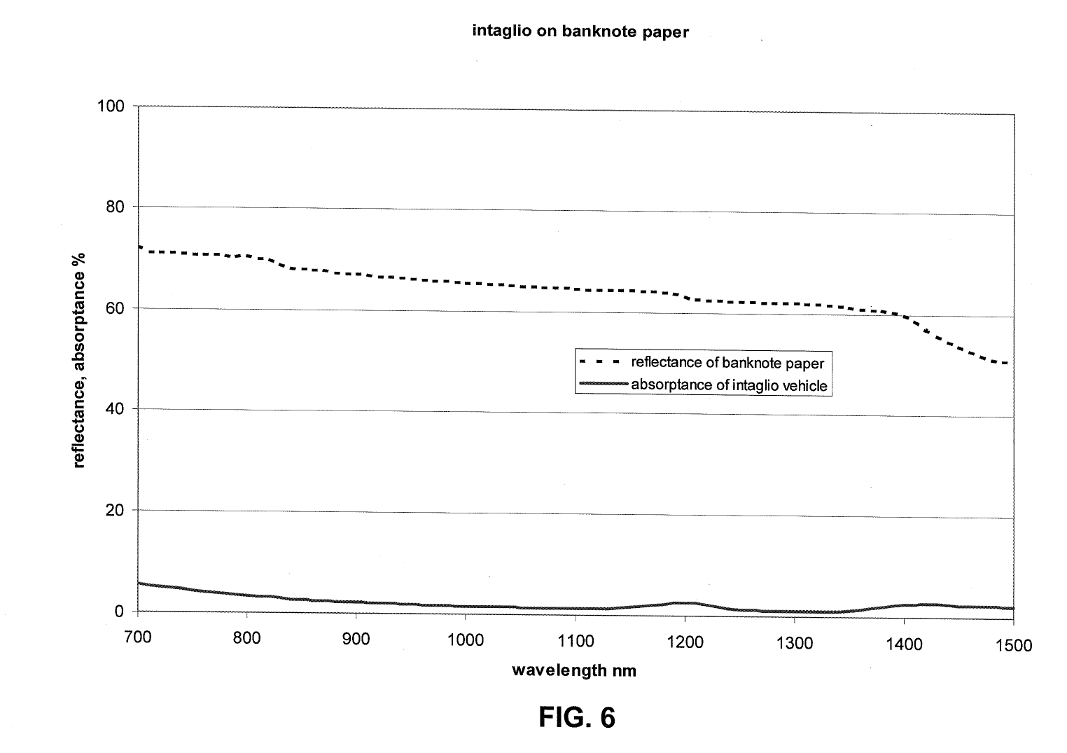

Referring once again to the primary embodiment of this invention wherein the flakes are heated by the light source having a wavelength matched to the absorption band of the flakes, the ink vehicle must be fairly transparent in the output wavelength band of the diodes to attain selective absorption by the pigment flakes. FIG. 6 shows a spectral scan of cured intaglio vehicle on banknote paper. The absorptance from the intaglio vehicle was calculated from reflectance scans made before and after the application of vehicle. It is evident not only that the banknote paper is highly reflective (about 70% near 810 nm) but also that the intaglio vehicle has very little absorption (about 5%) in that wavelength range.

The invention provides numerous advantages over the prior art. Advantageously in one embodiment the invention provides spatially-selective heating wherein only the fraction of substrate surface is exposed to the light beam. This will often take the form of a strip some tens of mm wide. In a preferred embodiment the invention provides material-selective heating wherein only the pigment flakes with a high absorptance for the heating wavelength will absorb energy. Being dispersed in and wetted by the ink vehicle, the flakes transfer heat to the vehicle by conduction and heat the vehicle adjacent to the flakes first. The laser diode array controlled by a suitably programmed controller controlling the power to the diode array can supply power modulated over a wide dynamic range from threshold output Oust above zero) to maximum output. Printing presses are typically started at a minimum speed and ramped to full production speed. The laser diode array controller can be programmed to supply power at a level matched to the press speed to maintain proper heating at a variety of speeds. Modulating may include modulating the drive current to the laser diode array, so as to maintain a constant power input corresponding to increase or decrease in press speed.

Modulation can accommodate press rapid shutdown: In the event of equipment failure or rapid operator-requested shutdown (“E-STOP”) the power to the laser diode, and thus the substrate heating, can be terminated immediately. In a rapid shutdown situation it is possible that paper substrate could be left in the orienting apparatus. In the prior art system the substrate would be at risk of thermal damage or, in the worst case, a fire hazard. Rapid termination of laser power mitigates or eliminates this risk. Compared to the prior art method of air heating or using heated rollers this invention allows for a lowered “thermal mass” of parts held at elevated temperature and allows a more rapid thermal response to changing operational requirements. Advantageously this invention also lends itself to improved safety properties by limiting the number and extent of heated parts to which a press operator could potentially be exposed. In a preferred embodiment of the invention, modulation can be controlled in a manner wherein there is synchrony with inked images on paper. For example, the power to the laser diode array can be modulated rapidly so that the maximum power is delivered only to the part of the substrate corresponding to an inked image, i.e. typically approximately 10% of the note's height with 8 to 10 note images being in the machine direction of the press.

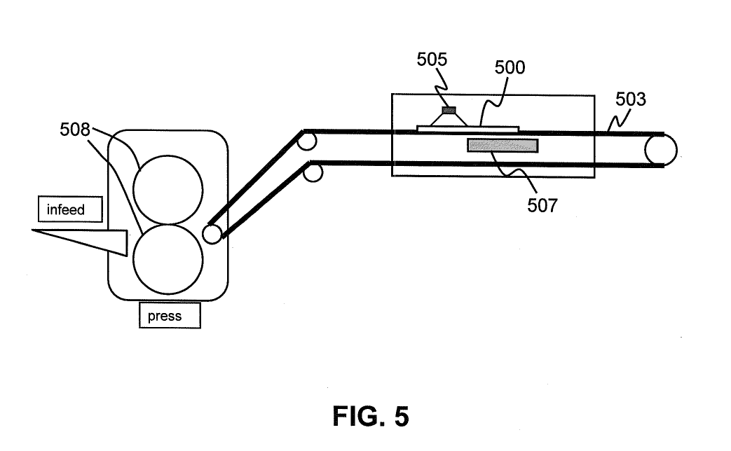

Turning now to FIG. 5, a schematic side view of an apparatus for high speed printing of magnetically aligned images in accordance with this invention is wherein a substrate 500 is carried by a moving conveyor belt or web 503. A diode laser heater 505 is shown above the substrate 500 and a magnetic assembly 507 is shown positioned below the substrate sequentially after the diode laser heater 505. Various rollers are shown which support and direct the conveyer belt along its path. At an input end of the apparatus is a pair of in-feed roller presses 508 which ink the substrate 500.

In summary, this invention provides a relatively low powered energy source to precisely heat target particles within a viscous ink so that the particles can be aligned in a magnetic or electric field. The low powered energy source in the form of laser diodes can be well controlled so that heating or terminating of heating can be done very rapidly as needed. As was mentioned heretofore, it is important to control switching on the power source and switching off the power source with rapidity for rapid heat and rapid cooling. This invention provides a method and means for achieving this.

What is claimed is:

1. A method of printing and aligning special effect flakes, such that at least some of the printed flakes orient along field lines of an applied field, the method comprising the steps of:
a) providing a paste-like ink, comprised of a carrier having flakes therein having an absorption band of wavelengths and a reflection band of wavelengths, wherein the absorption band is more absorbing than reflecting and wherein the reflecting band is more reflecting than absorbing and wherein the flakes are comprised of at least a layer of field orientable material;
b) applying the paste like ink by printing said ink upon a substrate;
c) lessening the viscosity of the paste-like ink by irradiating with one or more beams of light having an optical power, wherein at least 50% of the optical power of the one or more beams of light is in the absorption band of the flakes or the carrier; and,
d) reorienting the flakes using the applied field to form the image.

2. A method of printing as defined in claim 1, wherein at least 45% of the optical power of the one or more beams of light is in the absorption band of the flakes.

3. A method as defined in claim 1, further comprising the step of allowing the paste-like ink to recover its viscosity such that the aligned special effect flakes are preserved through the curing process of the ink.

4. A method as defined in claim 1, wherein the flakes of the paste-like ink are at least 50% absorbing over a band of wavelengths Wₐ₁ to Wₐ₂, and wherein the one or more beams of light provide optical energy in a band of wavelengths included within Wₐ₁ to Wₐ₂ so as to heat the flakes or ink vehicle or both, and thereby lessen the viscosity of the paste-like ink such that the flakes can be reoriented in the applied field, wherein the field is a magnetic field.

5. A method as defined in claim 1, wherein at least some of the flakes of the paste-like ink are at least 70% reflective over a band of wavelengths Wᵣ₁ to Wᵣ₂ and wherein said flakes are at least 70% absorbing over a band of wavelengths Wₐ₁ to Wₐ₂, wherein the step of lessening the viscosity of the paste like ink by adding optical energy includes utilizing an optical source having sufficient energy between the wavelengths Wₐ₁ and Wₐ₂.

6. A method as defined in claim 3, wherein the optical source includes one or more laser diodes having at least 80% of their optical energy within a band of wavelengths between Wₐ₁ and Wₐ₂.

7. A method as defined in claim 1, wherein at least some of the flakes of the paste like ink are at least 70% reflective at wavelengths Wᵣ₁ and Wᵣ₂ and wherein said flakes are at least 70% absorbing at a wavelength Wₐ between the wavelengths Wᵣ₁ and Wᵣ₂, and wherein the step of lessening the viscosity of the paste like ink by adding optical energy includes utilizing an optical source having sufficient energy between the wavelengths Wᵣ₁ and Wᵣ₂, and, wherein at least some of the flakes of the paste like ink are at least 60% reflective at wavelengths Wᵣ₃ and Wᵣ₄ and wherein at least some of said flakes are at least 60% absorbing at a wavelength Wₐ₂ between the wavelengths Wᵣ₃ and Wᵣ₄, and wherein the step of lessening the viscosity of the paste like ink by adding optical energy includes utilizing an optical source having sufficient energy between the wavelengths Wᵣ₃ and Wᵣ₄, wherein Wₐ is closer to Wᵣ₁ than to Wᵣ₃ and wherein Wᵣ₃ and Wᵣ₄ are not within a band of wavelengths between Wᵣ₁ and Wᵣ₂.

8. A method as defined in claim 7, wherein the optical source includes one or more laser diodes having at least 60% of their optical energy within a band of wavelengths between Wᵣ₃ and Wᵣ₄.

9. A method as defined in claim 1, wherein a mixture of different flakes are utilized and wherein the different flakes have different absorption characteristics with wavelength.

10. A method as defined in claim 1, wherein the step (c) is performed by modulating the one or more beams of light.

11. A method as defined in claim 10, wherein the step of modulating includes modulating the drive current to the laser diode array, so as to maintain a constant power input corresponding to increase or decrease in press speed.

12. A printing apparatus for aligning special effect flakes having an absorption band of wavelengths and a reflection band of wavelengths in a paste-like ink wherein the absorption band is more absorbing than reflecting and wherein the reflecting band is more reflecting than absorbing and wherein the flakes are comprised of at least a layer of field orientable material comprising:
a) means for moving a substrate coated with the paste-like ink;
b) means for generating one or more beams of light positioned to irradiate the paste-like ink coating on the substrate so as to lessening the viscosity of the paste like ink by irradiating with the one or more beams of light, wherein at least 50% of the optical power of the one or more beams of light is in the absorption band of the flakes; and,
c) means for providing a magnetic or electric filed for reorienting the flakes using the applied field to form the image.

13. A printing apparatus as defined in claim 12, wherein the means for generating one or more beams of light includes a laser diode array.

14. A printing apparatus as defined in claim 13, further comprising means for controlling the laser diode array so as to modulate its output in a controlled manner.

15. A printing apparatus as defined in claim 12, wherein the means for controlling the laser diode array includes a suitably programmed processor for controlling a power supply in a variable manner so as to control output power of the laser diode array.

16. A method of printing and aligning special effect flakes as defined in claim 1, wherein the step of lessening the viscosity of the paste-like ink includes by irradiating with one or more beams of light having an optical power, wherein at least 50% of the optical power of the one or more beams of light is in the absorption band of the carrier.

17. A method as defined in claim 16, wherein the step of irradiating includes irradiating with a plurality of laser diodes and wherein power supplied to the laser diodes is modulated in dependence upon a presence or absence of ink in particular regions of the substrate.
